(19) United States
(12) Patent Application Publication
(10) Pub. No.: US 2013/0249838 A1
(43) Pub. Date: Sep. 26, 2013

(54) TOUCH PANEL AND DISPLAY DEVICE MOUNTING THE SAME

(71) Applicant: JAPAN DISPLAY EAST INC., Mobara-shi (JP)

(72) Inventors: Emiko NAKAGAWA, Mobara-shi (JP); Setsuo KOBAYASHI, Mobara-shi (JP)

(73) Assignee: Japan Display East Inc., Mobara-shi (JP)

(21) Appl. No.: 13/833,708

(22) Filed: Mar. 15, 2013

(30) Foreign Application Priority Data
Mar. 22, 2012 (JP) 2012-064673

(51) Int. Cl. G06F 3/041

(52) U.S. Cl. CPC G06F 3/041
USPC 345/173

(57) ABSTRACT

There is provided a touch panel including: a substrate; plural X electrodes; and plural Y electrodes disposed so as to intersect with the plural X electrodes, wherein: the plural X electrodes and the plural Y electrodes have electrode parts and intersection parts; and a protective film is further provided on the plural X electrodes and the plural Y electrodes; and wherein the pencil hardness of the surface on the observer side of the protective film is 3 or higher to 7 or lower, more preferably, 4 or higher to 6 or lower.

### CLAIM OF PRIORITY

The present application claims priority from Japanese Patent Application JP2012-064673 filed on Mar. 22, 2012, the content of which is hereby incorporated by reference into this application.

### BACKGROUND OF THE INVENTION

1. Field of the Invention

The present invention relates to a touch panel and a display device mounting a touch panel, and particularly to a technique useful in reusing and recycling a touch panel.

2. Description of the Related Art

There has been known a touch panel using a touch panel hard coat film that is excellent in pen input durability, and the touch panel is disclosed in, for example, Japanese Patent Application Laid-Open No. 2004-269605. Further, a hybrid product obtained by attaching a front panel, a touch panel, and a liquid crystal display panel (liquid crystal display device) to each other has been recently manufactured.

In general, when attaching the panels of the hybrid product, ultraviolet cured resin (hereinafter, referred to as UV resin) is mainly used. If such a hybrid product is identified as defective in inspections such as a lighting inspection or an appearance inspection, UV resin adhering portions are discarded without reuse and recycle because UV resin is a cured film and is highly difficult to remove.

For example, if the hybrid product obtained by attaching the front panel, the touch panel, and the liquid crystal display panel to each other is identified as defective in inspections such as a lighting inspection or an appearance inspection, only the liquid crystal display panel is reused. On the other hand, it is highly difficult to remove the UV resin of an upper polarizing plate of the liquid crystal display panel, the front panel, and the touch panel. Thus, those UV resin adhering portions are discarded without reuse and recycle. Further, a backlight, an upper frame, and the like of the liquid crystal display panel are deformed when decomposing the hybrid product. Thus, those UV resin adhering portions are discarded without reuse and recycle.

### SUMMARY OF THE INVENTION

As described above, UV resin is used to attach components to each other in the hybrid product. However, almost all of UV resin adhering components are discarded because the UV resin is difficult to remove. Therefore, the amount of wasted components is disadvantageously increased.

In order to solve the above-described problems, the inventors of the present application have already applied for a patent of a cleaning method using a dry ice pellet as Japanese Patent Application No. 2011-198329 filed on Sep. 12, 2011. (U.S. patent application Ser. No. 13/609,298 filed on Sep. 11, 2012 claims priority from the Japanese Patent Application No. 2011-198329)

However, even if the cleaning method described in Japanese Patent Application No. 2011-198329 is used, the touch panels cannot be reused and recycled, and all of them with UV resin adhering are discarded.

The present invention has been made to solve the above-described problems in the prior art, and an object of the present invention is to provide a touch panel whose UV resin can be peeled off by a cleaning method using a dry ice pellet and which can be reused and recycled, and a display device mounting the same.

The above and other objects, and novel characteristics of the present invention will become apparent from the description of the specification and the accompanying drawings.

Although the present invention can be recognized from plural viewpoints, a touch panel and a display device mounting the same according to a representative aspect of the present invention from one viewpoint will be described below. Further, a touch panel and a display device mounting the same of the present invention from other viewpoints will become apparent from the following descriptions of a mode for carrying out the present invention.

The followings are summaries of representative aspects of the invention disclosed in the application.

(1) A touch panel including:

a substrate;

plural X electrodes formed on the substrate;

plural Y electrodes formed on the substrate so as to intersect with the plural X electrodes; and

a protective film provided on the plural X electrodes and the plural Y electrodes,

wherein the pencil hardness of the surface on the observer side of the protective film is 3 or higher to 7 or lower.

(2) A touch panel including:

a substrate;

plural X electrodes; and

plural Y electrodes disposed so as to intersect with the plural X electrodes, wherein:

the plural X electrodes and the plural Y electrodes have electrode parts and intersection parts;

the electrode parts and the intersection parts of the plural X electrodes and the electrode parts of the plural Y electrodes are formed on the substrate;

an insulating film is provided on the electrode parts and the intersection parts of the plural X electrodes and the electrode parts of the plural Y electrodes;

the intersection parts of the plural Y electrodes are formed on the insulating film;

each of the intersection parts of the plural Y electrodes allows the adjacent electrode parts of the plural Y electrodes to be electrically connected to each other through through-holes formed in the insulating film;

a protective film is provided on the intersection parts of the plural Y electrodes; and

the pencil hardness of the surface on the observer side of the protective film is 3 or higher to 7 or lower.

(3) A touch panel including:

a substrate;

plural X electrodes formed on the substrate;

an insulating film formed on the plural X electrodes;

plural Y electrodes formed on the insulating film so as to intersect with the plural X electrodes; and

a protective film provided on the plural Y electrodes,

wherein the pencil hardness of a surface on the observer side of the protective film is 3 or higher to 7 or lower.

(4) The touch panel according to any one of (1) to (3), wherein the pencil hardness of the surface on the observer side of the protective film is 4 or higher to 6 or lower.
(5) The touch panel according to any one of (1) to (3), wherein the pencil hardness of a surface opposed to that on the observer side of the protective film is lower than that of the surface on the observer side of the protective film.
(6) The touch panel according to any one of (1) to (3), wherein a front panel is provided on the protective film.
(7) The touch panel according to any one of (1) to (3), wherein a transparent conductive film is provided on the surface opposed to that of the substrate on which the X electrodes and the Y electrodes are formed.
(8) A display device mounting a touch panel including:

a display panel; and

a touch panel provided on the display panel,

the touch panel including:

a substrate;

plural X electrodes formed on the substrate;

plural Y electrodes formed on the substrate so as to intersect with the plural X electrodes; and

a protective film provided on the plural X electrodes and the plural Y electrodes,

wherein the pencil hardness of the surface on the observer side of the protective film is 3 or higher to 7 or lower.

(9) A display device mounting a touch panel including:

a display panel; and

a touch panel provided on the display panel,

the touch panel including:

a substrate;

plural X electrodes; and

plural Y electrodes disposed so as to intersect with the plural X electrodes,

wherein the plural X electrodes and the plural Y electrodes have electrode parts and intersection parts;

the electrode parts and the intersection parts of the plural X electrodes and the electrode parts of the plural Y electrodes are formed on the substrate;

an insulating film is provided on the electrode parts and the intersection parts of the plural X electrodes and the electrode parts of the plural Y electrodes;

the intersection parts of the plural Y electrodes are formed on the insulating film;

each of the intersection parts of the plural Y electrodes allows the adjacent electrode parts of the plural Y electrodes to be electrically connected to each other through through-holes formed in the insulating film;

a protective film is provided on the intersection parts of the plural Y electrodes; and

the pencil hardness of a surface on the observer side of the protective film is 3 or higher to 7 or lower.

(10) A display device mounting a touch panel including:

a display panel; and

a touch panel provided on the display panel,

the touch panel including:

a substrate;

plural X electrodes formed on the substrate;

an insulating film formed on the plural X electrodes;

plural Y electrodes formed on the insulating film so as to intersect with the plural X electrodes; and

a protective film provided on the plural Y electrodes,

wherein the pencil hardness of a surface on the observer side of the protective film is 3 or higher to 7 or lower.

(11) The display device mounting a touch panel according to any one of (8) to (10), wherein the display panel is a liquid crystal display panel using a liquid crystal display device.
(12) The display device mounting a touch panel according to any one of (8) to (10), wherein the pencil hardness of the surface on the observer side of the protective film is 4 or higher to 6 or lower.
(13) The display device mounting a touch panel according to any one of (8) to (10), wherein the pencil hardness of a surface opposed to that on the observer side of the protective film is lower than that of the surface on the observer side of the protective film.
(14) The display device mounting a touch panel according to any one of (8) to (10), wherein a front panel is provided on the protective film.
(15) The display device mounting a touch panel according to any one of (8) to (10), wherein a transparent conductive film is provided on the surface opposed to that of the substrate on which the X electrodes and the Y electrodes are formed.

The following is a summary of an effect obtained by representative aspects of the invention disclosed in the application.

According to a touch panel of the present invention, UV resin can be peeled off by a cleaning method using a dry ice pellet and the touch panel can be reused and recycled.

### BRIEF DESCRIPTION OF THE DRAWINGS

FIG. 1 is a diagram for showing an outline configuration of a liquid crystal display device mounting a touch panel according to an embodiment of the present invention;

FIG. 2 is a plan view for showing a configuration of electrodes of the touch panel shown in FIG. 1;

FIG. 3 is a cross-sectional view for showing a cross-sectional structure of the touch panel shown in FIG. 1;

FIG. 4 is a patterned mechanism view for performing a cleaning method using a dry ice pellet by Japanese Patent Application No. 2011-198329;

FIGS. 5A, 5B, 5C, and 5D are diagrams each explaining the cleaning method using a dry ice pellet by Japanese Patent Application No. 2011-198329;

FIG. 6 is a diagram for explaining a concrete configuration according to the cleaning method using a dry ice pellet by Japanese Patent Application No. 2011-198329;

FIG. 7 is a diagram for explaining a concrete configuration according to the cleaning method using a dry ice pellet by Japanese Patent Application No. 2011-198329;

FIGS. 8A, 8B, and 8C are diagrams each showing a cross-sectional shape of a nozzle shown in FIG. 4; and

FIG. 9 is a diagram for explaining a protective film according to the embodiment of the present invention.

### DETAILED DESCRIPTION OF THE INVENTION

Hereinafter, an embodiment of the present invention will be described in detail with reference to the drawings.

It should be noted that constitutional elements having the same functions are given the same reference numerals in the all drawings for explaining the embodiment, and the explanations thereof will not be repeated. Further, the following embodiment does not limit the interpretation of claims of the present invention.

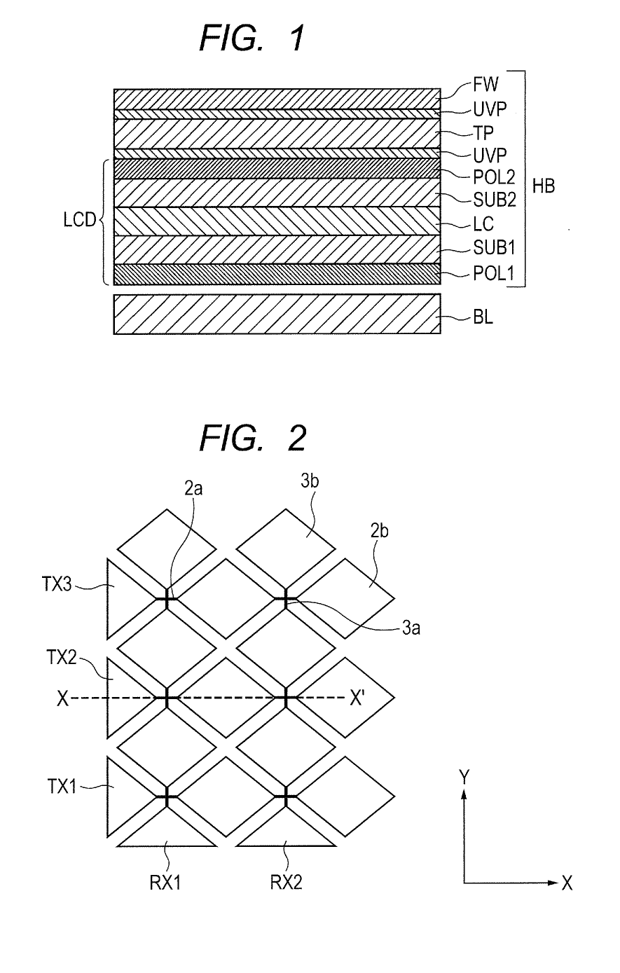

FIG. 1 is a patterned cross-sectional view for showing an outline configuration of a liquid crystal display device mounting a touch panel according to an embodiment of the present invention.

In FIG. 1, FW, LCD, TP, and BL denote a front panel (or also referred to as a front window), a liquid crystal display panel, a touch panel, and a backlight, respectively.

The display device mounting a touch panel of the embodiment is a hybrid product (HB) obtained by attaching the front panel (FW), the liquid crystal display panel (LCD) using a liquid crystal display device, and the touch panel (TP) to each other.

The liquid crystal display panel (LCD) includes a first substrate (for example, a glass substrate) SUB1, a second substrate (for example, a glass substrate) SUB2, and a liquid crystal layer (LC) sandwiched between the first substrate (SUB1) and the second substrate (SUB2). In addition, a lower polarizing plate (POL1) is formed on the first substrate (SUB1) (the backlight (BL) side), and an upper polarizing plate (POL2) is formed on the second substrate (SUB2) (the observer side). It should be noted that details of electrodes, oriented films, filters, and the like provided in a normal liquid crystal display panel (LCD) are not illustrated in FIG. 1.

In FIG. 1, the touch panel (TP) is attached on the upper polarizing plate (POL2) of the liquid crystal display panel (LCD) through a UV resin (UVP), and the front panel (FW) is attached on the touch panel (TP) through another UV resin (UVP).

On the liquid crystal layer side of the first substrate (SUB1), formed are scanning lines (also referred to as gate lines), opposed electrodes (also referred to as common electrodes), interlayer insulating films, video lines (also referred to as source lines or drain lines), thin-film transistors, pixel electrodes, oriented films, and the like from the first substrate (SUB1) towards the liquid crystal layer. However, these elements are not illustrated in FIG. 1 as similar to the above.

On the liquid crystal layer side of the second substrate (SUB2), formed are light blocking films, red/green/blue color filters, planarizing films, oriented films, and the like from the second substrate towards the liquid crystal layer. However, these elements are not illustrated in FIG. 1 as similar to the above.

The liquid crystal display panel (LCD) is configured in such a manner that the first substrate (SUB1) on which pixel electrodes, thin-film transistors (TFTs) and the like are formed and the second substrate (SUB2) on which color filters and the like are formed are overlapped with each other while having a predetermined gap, and are attached to each other using a seal member (not shown) provided in a frame shape near the edges of the both substrates. In addition, liquid crystal is enclosed and sealed inside the seal member between the both substrates from a liquid crystal enclosing port provided at a part of the seal member, and further polarizing plates are attached to the outsides of the both substrates.

It should be noted that the opposed electrodes can be applied to a TN (Twisted Nematic)-type or VA (Vertically Aligned)-type liquid crystal display device. In the case of the TN-type or VA-type liquid crystal display panel, the opposed electrodes are provided on the second substrate side. In the case of an IPS (In-Plane Switching)-type, the opposed electrodes are provided on the first substrate side.

In addition, the present invention is not related to an inner structure of a liquid crystal panel, and thus detailed explanations thereof are omitted. Further, the present invention can be applied to liquid crystal panels of any type.

FIG. 2 is a plan view for showing an electrode structure of the touch panel (TP) shown in FIG. 1.

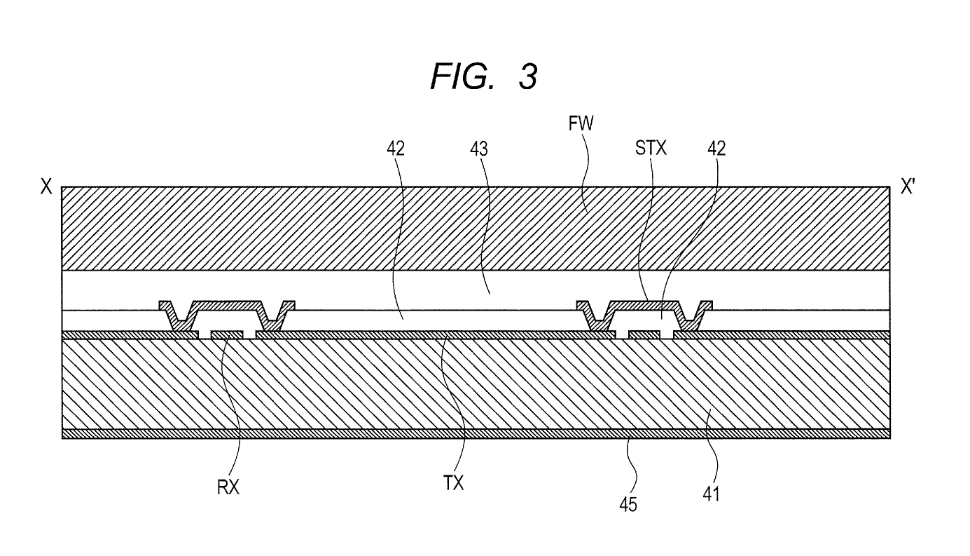

FIG. 3 is a cross-sectional view for showing a cross-sectional structure of the touch panel (TP) shown in FIG. 1.

The touch panel (TP) of the embodiment includes, as shown in FIG. 2, scanning electrode (also referred to as Y electrodes) (TX) for capacity detection and detection electrodes (RX) (also referred to as X electrodes). In the drawing, for example, three scanning electrodes (TX) (TX1 to TX3) and two detection electrodes (RX) (RX1 and RX2) are illustrated to simplify the explanation. However, more electrodes are provided.

Further, the touch panel (TP) includes, as shown in FIG. 3, a touch panel substrate 41, the scanning electrodes (TX) and the detection electrodes (RX) formed on the touch panel substrate 41, an interlayer insulating film 42 formed on the scanning electrodes (TX) and the detection electrodes (RX), connection parts (STX) that are formed on the interlayer insulating film 42 to electrically connect the scanning electrodes (TX) to each other, a protective film 43 formed on the connection parts (STX), and a shielding transparent electrode (for example, an electrode formed using an ITO (Indium Tin Oxide) film) 45 formed on the liquid crystal display panel side of the touch panel substrate 41.

It should be noted that the front panel (FW) is disposed on the protective film 43. Further, for example, a transparent insulating substrate such as glass is used as the substrate 41. In addition, the shielding transparent electrode 45 is not formed in some cases. Further, FIG. 3 is a cross-sectional view for showing a cross-sectional structure along the line X-X′ shown in FIG. 2.

As shown in FIG. 2, each of plural scanning electrodes (TX) is formed as an electrode pattern in which intersection parts 2a (the connection parts (STX) of FIG. 3) and electrode parts 2b each having a width larger than that of the intersection part 2a are alternately disposed in the first direction (X direction of FIG. 2).

Further, as shown in FIG. 2, each of plural detection electrodes (RX) is formed as an electrode pattern in which intersection parts 3a and electrode parts 3b each having a width larger than that of the intersection part 3a are alternately disposed in the second direction (Y direction of FIG. 2).

Each of the intersection parts 2a of plural scanning electrodes (TX) is formed on the interlayer insulating film 42 to insulate and separate the detection electrodes (RX). The intersection parts 2a vertically intersect with the intersection parts 3a of the detection electrodes (RX), and electrically and mechanically connect, through contact holes formed in the interlayer insulating film 42, two electrode parts 2b that are adjacent to each other while sandwiching the intersection part 2a.

The intersection parts 3a of the detection electrodes (RX) vertically intersect with the intersection parts 2a of the scanning electrodes (TX). When viewed in the planar direction, each of the electrode parts 2b of the scanning electrodes (TX) is disposed between the intersection parts 3a of the adjacent two detection electrodes (RX), and each of the electrode parts 3b of the detection electrodes (RX) is disposed between the intersection parts 2a of the adjacent two scanning electrodes (TX).

In this case, the electrode parts 3b of the detection electrodes (RX) and the electrode parts 2b of the scanning electrodes (TX) are formed in a rhombus shape when viewed from the direction (viewed in the planar direction) orthogonal to the substrate 41.

It should be noted that the detection electrodes (RX) and the scanning electrodes (TX) are formed using a material with a high transmissivity, for example, a transparent conductive material such as ITO (Indium Tin Oxide).

The touch panel (TP) is installed on the front face of the liquid crystal display panel. Accordingly, when a user views an image displayed on the liquid crystal display panel (LCD), the displayed image needs to penetrate the touch panel (TP), and thus the optical transmissivity of the touch panel (TP) is desirably high.

It should be noted that other than the above-described configuration of the touch panel (TP), the touch panel (TP) may include a substrate, plural detection electrodes (RX) formed on the substrate, an insulating film formed on plural detection electrodes (RX), plural scanning electrodes (TX) each formed on the insulating film so as to intersect with each of plural detection electrodes (RX), and a protective film formed on plural scanning electrodes (TX).

[Cleaning Method Using Dry Ice Pellet in the Invention of Japanese Patent Application No. 2011-198329]

In a cleaning method using a dry ice pellet in the invention of Japanese Patent Application No. 2011-198329, for example, if the hybrid product obtained by attaching the front panel (FW) and the liquid crystal display panel (LCD) shown in FIG. 1 to each other is identified as defective in inspections such as a lighting inspection or an appearance inspection, the UV resins (UVP) through which the front panel (FW) and the liquid crystal display panel (LCD) are attached to each other are divided at the bonding faces, and the UV resins (UVP) remaining on the bonding faces of the upper polarizing plate (POL2) of the liquid crystal display panel (LCD) and the front panel (FW) are removed by using dry ice pellets.

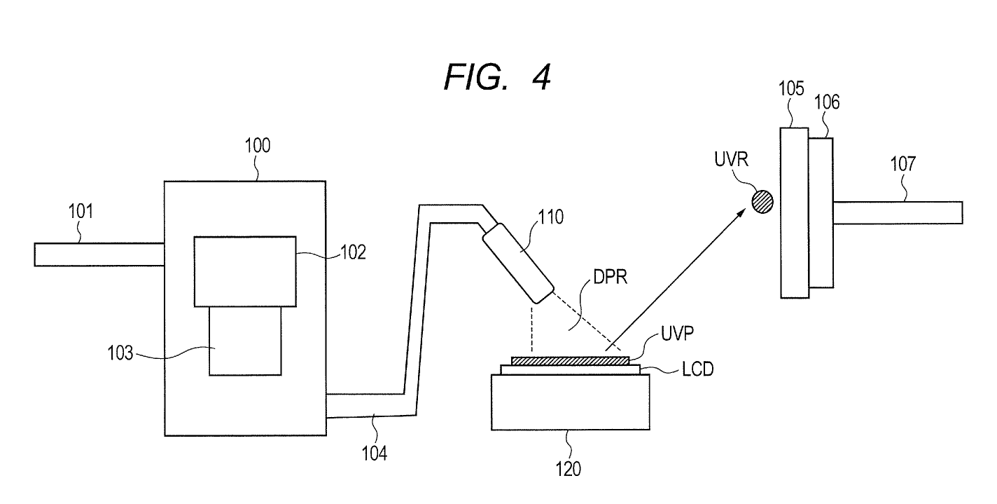

FIG. 4 is a patterned mechanism view for performing the cleaning method using a dry ice pellet in the invention of Japanese Patent Application No. 2011-198329.

In FIG. 4, the reference numeral 100 denotes a dry ice blast device to which dry air is supplied through a dry air pipe 101. Further, only a predetermined amount of dry ice pellets is input into the dry ice blast device 100 from a dry ice slot 102 of the dry ice blast device 100 by an input limiting device 103.

The dry ice blast device 100 adjusts the amount of dry air, and outputs the dry ice pellets and dry air to a pressure feeding hose 104 to blast from a nozzle 110 to a cleaning object (the liquid crystal display panel (LCD) in FIG. 4; hereinafter, simply referred to as an object) fixed on a fixing jig 120. Accordingly, the UV resin (UVP) remaining on the liquid crystal display panel (LCD) is removed.

The removed UV resin (UVR) is sucked from an air duct 105 together with air sucked through an air duct pipe 107 and is captured by a filter 106.

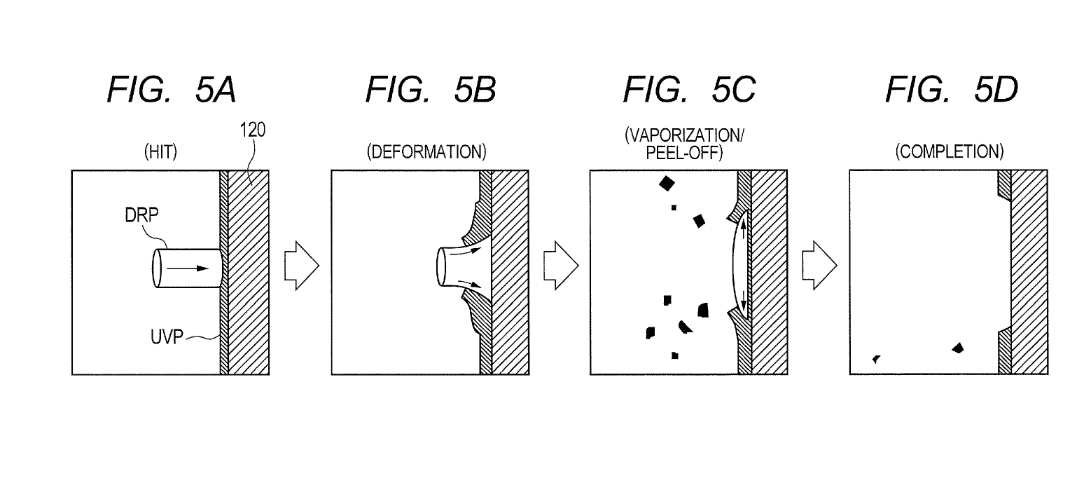

FIGS. 5A to 5D are diagrams each explaining the cleaning method using a dry ice pellet in the invention of Japanese Patent Application No. 2011-198329. Hereinafter, the cleaning method using a dry ice pellet by Japanese Patent Application No. 2011-198329 will be described using FIGS. 5A to 5D.

First, a dry ice pellet (DPR) is accelerated by dry air from the nozzle 110 provided at the tip end of the pressure feeding hose 104 of the dry ice blast device 100, and is sprayed to the surface of the object (BUH) (see FIG. 5A).

Accordingly, the dry ice pellet (DPR) enters inside the UV resin (UVP) adhering on the surface of the object (BUH) (see FIG. 5B). In this case, the UV resin (UVP) is drastically cooled down, and the drastic temperature difference advantageously causes the adhering UV resin (UVP) to be peeled off.

The Mohs hardness of the dry ice pellet (DPR) is 2 or smaller. Thus, if the dry ice pellet (DPR) hits the surface of the object (BUH), the dry ice pellet (DPR) spreads in the lateral direction to enter between the UV resin (UVP) and the object (BUH). Then, the dry ice pellet (DPR) is drastically vaporized and the volume thereof is expanded. The change in volume widens the gap, and blasts off the UV resin (UVP) (see FIG. 5C).

The dry ice pellet (DPR) sprayed from the nozzle 110 instantly sublimates to become carbon dioxide. Thus, no residual material remains (see FIG. 5D).

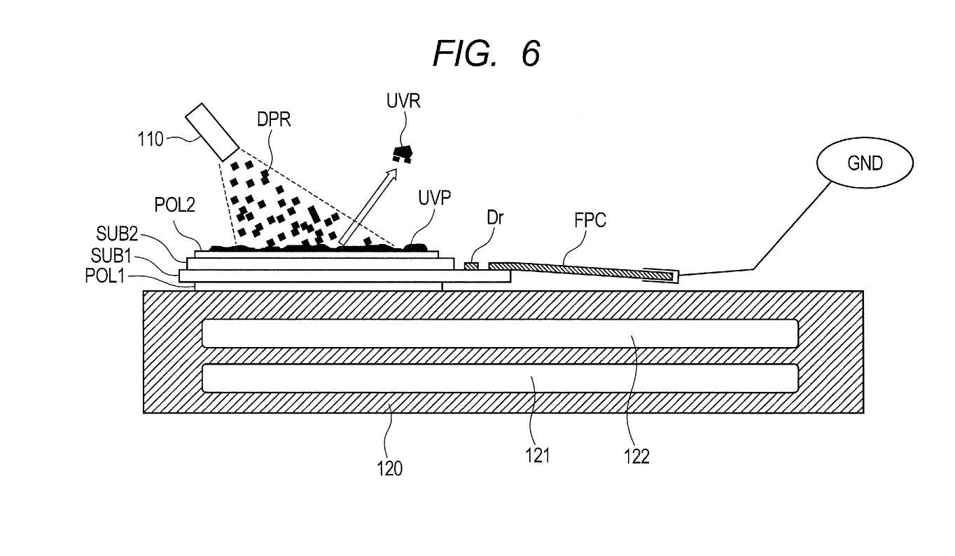

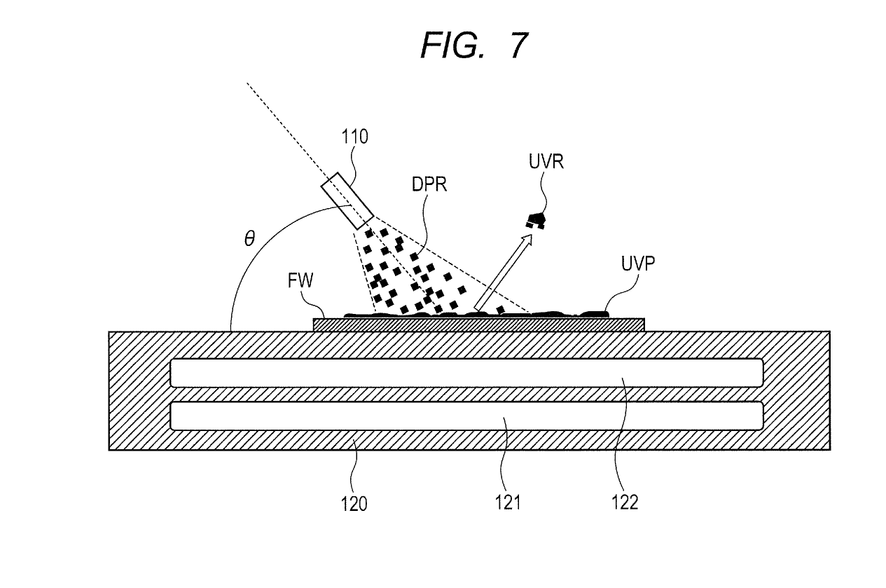

FIG. 6 and FIG. 7 are diagrams each explaining the cleaning method using a dry ice pellet in the invention of Japanese Patent Application No. 2011-198329.

FIG. 6 is a diagram for explaining a state in which if the hybrid product obtained by attaching the front panel (FW), the touch panel (TP), and the liquid crystal display panel (LCD) to each other is identified as defective in inspections such as a lighting inspection or an appearance inspection, the UV resin (UVP) through which the touch panel (TP) and the liquid crystal display panel (LCD) are attached to each other is divided at the bonding face, and the UV resin (UVP) remaining on the bonding face of the upper polarizing plate (POL2) of the liquid crystal display panel (LCD) is removed by blasting with the dry ice pellets (DPR). In FIG. 6, the liquid crystal layer (LC) sandwiched between the first substrate (SUB1) and the second substrate (SUB2) of the liquid crystal display panel (LCD) is not illustrated for simplification.

FIG. 7 is a diagram for explaining a state in which the UV resin (UVP) through which the front panel (FW) and the touch panel (TP) are attached to each other is divided at the bonding face, and the UV resin (UVP) remaining on the bonding face of the front panel (FW) is removed by blasting with the dry ice pellets (DPR).

In each of FIG. 6 and FIG. 7, the reference numeral 120 denotes the fixing jig that includes a heating mechanism 121 to heat the object (the liquid crystal display panel (LCD) in FIG. 6) for the purpose of dew condensation prevention for the surface in contact with the dry ice pellets, and an absorption mechanism (for example, a vacuum absorption mechanism) 122 to fix the object so as not to fly when the dry ice pellets (DPR) are accelerated by dry air to be sprayed to the surface of the object.

In FIG. 6, the dry ice blast device 100 adjusts the amounts of dry air and dry ice pellets (DPR), and outputs the dry ice pellets (DPR) and dry air to the pressure feeding hose 104 to blast from the nozzle 110 to the upper polarizing plate (POL2) of the liquid crystal display panel (LCD) fixed on the fixing jig 120. Accordingly, the UV resin (UVP) remaining on the upper polarizing plate (POL2) of the liquid crystal display panel (LCD) is removed.

However, in FIG. 6, in order to prevent charge-up damage of the liquid crystal display panel (LCD) due to frictional charging of the dry ice pellets (DPR), a terminal of a flexible printed circuit board (FPC) that is electrically and mechanically fixed to one side of the first substrate (SUB1) to input display data and control signals to a driver (Dr) is connected to a ground potential (GND), and charge is allowed to always flow to the ground potential (GND).

Further, in FIG. 7, the dry ice blast device 100 adjusts the amounts of dry air and dry ice pellets (DPR), and outputs the dry ice pellets (DPR) and dry air to the pressure feeding hose 104 to blast from the nozzle 110 to the front panel (FW) fixed on the fixing jig 120. Accordingly, the UV resin (UVP) remaining on the front panel (FW) is removed.

As described above, in each of FIG. 6 and FIG. 7, the UV resin (UVP) can be efficiently peeled off by using the dry ice pellets (DPR) without scratching and dew condensation on the surfaces of the upper polarizing plate (POL2) of the liquid crystal display panel (LCD) and the front panel (FW).

Hereinafter, the conditions of the cleaning method using a dry ice pellet in the invention of Japanese Patent Application No. 2011-198329 will be described.

### (1) Cross-Sectional Shape of Nozzle 110

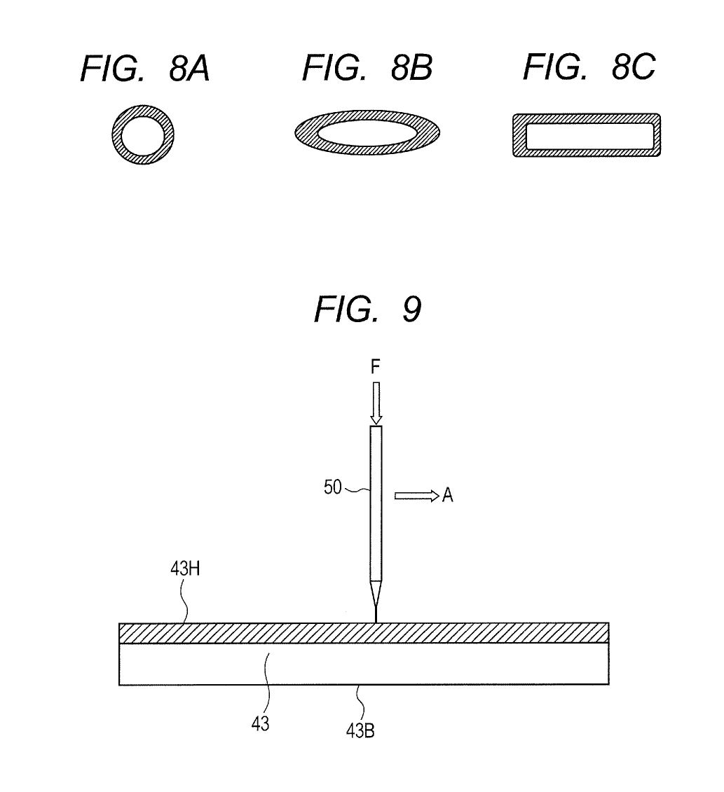

If the cross-section of the nozzle 110 is in a circular shape as shown in FIG. 8A, it is effective in removing the UV resin (UVP) at peripheral parts, minute parts, and point parts. Further, if the cross-section of the nozzle 110 is in an elliptical shape or rectangular shape as shown in FIG. 8B and FIG. 8C, it is effective in removing the UV resin (UVP) in a wide range. The number of times of reciprocation of the nozzle 110 can be reduced, and the UV resin (UVP) can be removed in a short time.

### (2) Distance Between Nozzle 110 and Object

The distance between the nozzle 110 and the cleaning object is optimally 5 mm to 70 mm. If the distance between the nozzle 110 and the object is 5 mm or shorter, there is a risk that the surface of the object is scratched, or print patterns printed on the surface of the object are peeled off. Further, if the distance between the nozzle 110 and the object is 5 mm or shorter, the surface temperature of the object is lowered, resulting in dew condensation, or the removing efficiency is disadvantageously deteriorated due to the small removal area by the dry ice pellets (DPR).

Further, the distance between the nozzle 110 and the object is 70 mm or longer, the hit impact of the dry ice pellets (DPR) is reduced, and the removing efficiency is disadvantageously deteriorated.

### (3) Angle of Nozzle 110 (θ of FIG. 7)

It is necessary to appropriately determine the angle of the nozzle 110 in accidence with the position and area of adhering material to be removed. If the angle of the nozzle 110 is vertical (90°) to the surface of the object, the dry ice pellets (DPR) sprayed from the nozzle 110 hit the surface of the object and are disadvantageously diffused. Further, if the angle of the nozzle 110 is small, the contact angle between the surface of the object and the dry ice pellets (DPR) becomes small. Thus, the removing efficiency is disadvantageously deteriorated. Therefore, the angle of the nozzle 110 is optimally 30° to 80°.

### (4) Heating Temperature

It is necessary to keep the temperature of the surface of the object at at least 20° C. to 80° C. to prevent dew condensation of the surface (the removing surface of the UV resin (UVP) in each of FIG. 6 and FIG. 7) of the object.

Therefore, the heating mechanism 121 is provided at the fixing jig 120 in each of FIG. 6 and FIG. 7. However, it is possible to heat the object from the surface side thereof. For example, warm air may be directly blown to the surface of the object for heating, light (infrared lamp or fluorescent lamp) may be directly irradiated onto the surface of the object for heating, or the entire temperature of air around the object may be heated (atmospheric heating) by an air conditioner or stove.

### (5) Dew Point of Dry Air

The dew point of dry air is optimally −60° C. to −80° C. The sublimation temperature of dry ice is −79° C. Thus, if the dew-point temperature is high, moisture contained in the dry air is condensed when the dry ice pellets (DPR) are sprayed from the nozzle 110. Therefore, the cleaning efficiency is deteriorated.

### (6) Shape of Dry Ice Pellet (DPR)

The diameter of the dry ice pellet (DPR) is appropriately 1 mm to 3 mm. If the diameter of the dry ice pellet (DPR) is 1 mm or smaller, the removing efficiency is disadvantageously deteriorated due to the small surface area of the dry ice pellet (DPR).

Further, if the diameter of the dry ice pellet (DPR) is 3 mm or larger, the contact point at the time of blast becomes large and irregularities of removal at the time of removing are likely to occur due the large surface area of the dry ice pellet (DPR).

Further, the length of the dry ice pellet (DPR) is preferably 1 mm to 5 mm, and more preferably, 1 mm to 3 mm.

However, even if the cleaning method using a dry ice pellet in the invention of Japanese Patent Application No. 2011-198329 is used, the touch panel (TP) is discarded without reuse and recycle.

The reason is as follows. Specifically, if the hybrid product obtained by attaching the front panel (FW), the touch panel (TP), and the liquid crystal display panel (LCD) to each other is identified as defective in inspections such as a lighting inspection or an appearance inspection, the UV resin (UVP) through which the touch panel (TP) and the liquid crystal display panel (LCD) are attached to each other is divided at the bonding face, and the UV resin (UVP) through which the front panel (FW) and the touch panel (TP) are attached to each other is divided at the bonding face.

In this case, the UV resins (UVP) remain on the surface on the liquid crystal display panel (LCD) side of the touch panel (TP) and the surface on the front panel (FW) side of the touch panel (TP).

As shown in FIG. 3, the shielding transparent electrode 45 (if the shielding transparent electrode 45 is not formed, the substrate 41 is formed) is formed on the surface on the liquid crystal display panel (LCD) side of the touch panel (TP). Thus, if the dry ice pellets (DPR) are allowed to blast, the remaining UV resin (UVP) can be removed without damaging the touch panel (TP).

However, the protective film 43 is formed on the surface on the front panel (FW) side of the touch panel (TP). Thus, when the dry ice pellets (DPR) are allowed to blast to remove the UV resin (UVP), the protective film 43 as well as the scanning electrodes (TX) and the detection electrodes (RX) are damaged, and the touch panel (TP) is damaged in some cases.

Therefore, even if the cleaning method using a dry ice pellet in the invention of Japanese Patent Application Laid-Open No. 2011-198329 is used, the touch panel (TP) is discarded without reuse and recycle.

### [Characteristics of the Present Invention]

In order to reuse and recycle the touch panel (TP) by solving the above-described problems, characteristics of the present invention is in that the pencil hardness of the surface on the front panel (FW) side (namely, the surface of the observer side) of the protective film 43 is 3 or higher to 7 or lower, more preferably, 4 or higher to 6 or lower.

Accordingly, the UV resin (UVP) remaining on the bonding face of the protective film 43 on the surface on the front panel (FW) side of the touch panel (TP) can be efficiently peeled off by blasting with the dry ice pellets (DPR) without scratching and dew condensation on the surface of the protective film 43 of the touch panel (TP) in the present invention.

In this case, if the pencil hardness of the surface of the protective film 43 is lower than 3, the surface of the protective film 43 is disadvantageously scratched by blasting with the dry ice pellets (DPR) when the cleaning method using a dry ice pellet is employed. If the pencil hardness of the surface of the protective film 43 is higher than 7, the protective film 43 is disadvantageously cracked when a heating cycle is added in the cleaning method using a dry ice pellet. Accordingly, the pencil hardness of the surface of the protective film 43 is preferably 3 or higher to 7 or lower.

Further, if the pencil hardness of the surface of the protective film 43 is 3 or higher to lower than 4 and higher than 6 to 7 or lower, setting of the conditions of the cleaning method using a dry ice pellet becomes difficult. On the other hand, if the pencil hardness of the surface of the protective film 43 is 4 or higher to 6 or lower, setting of the conditions of the cleaning method using a dry ice pellet becomes easy. Thus, the pencil hardness of the surface of the protective film 43 is preferably 4 or higher to 6 or lower.

Hereinafter, a pencil hardness test method of the embodiment will be described using FIG. 9.

In FIG. 9, the reference numeral 43 denotes the protective film; 43H, a hard coat part of the protective film 43; and 50, a pencil.

In the pencil hardness test method of the embodiment, for example, a load F (in this case, 1 Kg) is, as shown in FIG. 9, applied to the pencil 50 in accordance with a test method as stipulated in JIS (Japanese Industrial Standard) K 5600, the pencil 50 is pulled in the direction of the arrow A to check whether or not the surface of the hard coat part 43H of the protective film 43 is scratched, and the pencil hardness of the surface of the hard coat part 43H of the protective film 43 is determined.

For example, in the case where the surface of the hard coat part 43H of the protective film 43 is not scratched with a pencil of 3H or lower and the surface of the hard coat part 43H of the protective film 43 is scratched with the pencil 50 of 4H, it is determined that the pencil hardness of the surface of the hard coat part 43H of the protective film 43 is 3.

Further, the pencil hardness of the surface of the hard coat part 43H of the protective film 43 is higher than that of the surface (the surface denoted by 43B in FIG. 9) on the liquid crystal display panel (LCD) side of the protective film 43 shown in FIG. 9 in the embodiment.

After such a protective film 43 is produced using light curing resin configured using, for example, an acrylic resin system and an epoxy resin system, the hard coat part 4314 is produced using light curing resin with the same material and a different density. Accordingly, two layers with different degrees of pencil hardness can be formed.

However, since the two layers are fused, the protective film 43 and the hard coat part 43H cannot be definitely distinguished from each other. However, a two-layer structure is illustrated in FIG. 9 for convenience sake.

However, the present invention is characterized in that the pencil hardness of the surface on the front panel (FW) side (namely, the surface on the observer side) of the protective film 43 of the touch panel (TP) is preferably 3 or higher to 7 or lower, more preferably, 4 or higher to 6 or lower.

The invention achieved by the inventors has been concretely described above on the basis of the embodiment. However, the present invention is not limited to the embodiment, but can be variously changed without departing from the gist of the present invention.

Further, the present invention is not limited to the above-described embodiment, but includes various modifications. For example, the embodiment has been described in detail to understandably explain the present invention, and is not necessarily limited to one having the all constitutional elements described above. Further, a part of the configuration in one embodiment can be replaced by a configuration of another embodiment, and the configuration in one embodiment can be added to another embodiment. In addition, a part of the configuration in the embodiment can be added to or replaced by another, or deleted.

Although the reference numerals have been described in the embodiment using the drawings, the main reference numerals will be described below again.
2a, 3a . . . intersection part
2b, 3b . . . electrode part
41 . . . substrate
42 . . . interlayer insulating film
43 . . . protective film
43H . . . hard coat part
45 . . . shielding transparent electrode
50 . . . pencil
100 . . . dry ice blast device
101 . . . dry air pipe
102 . . . dry ice slot
103 . . . input limiting device
104 . . . pressure feeding hose
105 . . . air duct
106 . . . filter
107 . . . air duct pipe
110 . . . nozzle
120 . . . fixing jig
121 . . . heating mechanism
122 . . . absorption mechanism
Dr . . . driver
FPC . . . flexible printed circuit board
FW . . . front panel (or also referred to as front window)
LCD . . . liquid crystal display panel
TP . . . touch panel
BL . . . backlight
STX . . . connection part
SUB1 . . . first substrate (for example, glass substrate)
SUB2 . . . second substrate (for example, glass substrate)
POL1 . . . lower polarizing plate
POL2 . . . upper polarizing plate
UVP . . . ultraviolet cured resin
UVR . . . removed ultraviolet cured resin
DPR . . . dry ice pellet
BUH . . . object
TX . . . scanning electrode (Y electrode) of touch panel
RX . . . detection electrode (X electrode) of touch panel

What is claimed is:

1. A touch panel comprising:
a substrate;
a plurality of X electrodes formed on the substrate;
a plurality of Y electrodes formed on the substrate so as to intersect with the plurality of X electrodes; and
a protective film provided on the plurality of X electrodes and the plurality of Y electrodes, wherein
the pencil hardness of the surface on the observer side of the protective film is 3 or higher to 7 or lower.

2. A touch panel comprising:
a substrate;
a plurality of X electrodes; and
a plurality of Y electrodes disposed so as to intersect with the plurality of X electrodes, wherein:
the plurality of X electrodes and the plurality of Y electrodes have electrode parts and intersection parts;
the electrode parts and the intersection parts of the plurality of X electrodes and the electrode parts of the plurality of Y electrodes are formed on the substrate;
an insulating film is provided on the electrode parts and the intersection parts of the plurality of X electrodes and the electrode parts of the plurality of Y electrodes;
the intersection parts of the plurality of Y electrodes are formed on the insulating film;
each of the intersection parts of the plurality of Y electrodes allows the adjacent electrode parts of the plurality of Y electrodes to be electrically connected to each other through through-holes formed in the insulating film;
a protective film is provided on the intersection parts of the plurality of Y electrodes; and
the pencil hardness of the surface on the observer side of the protective film is 3 or higher to 7 or lower.

3. A touch panel comprising:
a substrate;
a plurality of X electrodes formed on the substrate;
an insulating film formed on the plurality of X electrodes;
a plurality of Y electrodes formed on the insulating film so as to intersect with the plurality of X electrodes; and
a protective film provided on the plurality of Y electrodes, wherein
the pencil hardness of the surface on the observer side of the protective film is 3 or higher to 7 or lower.

4. The touch panel according to any one of claims 1 to 3, wherein the pencil hardness of the surface on the observer side of the protective film is 4 or higher to 6 or lower.

5. The touch panel according to any one of claims 1 to 3, wherein the pencil hardness of the surface opposed to that on the observer side of the protective film is lower than that of the surface on the observer side of the protective film.

6. The touch panel according to any one of claims 1 to 3, wherein a front panel is provided on the protective film.

7. The touch panel according to any one of claims 1 to 3, wherein a transparent conductive film is provided on the surface opposed to that of the substrate on which the X electrodes and the Y electrodes are formed.

8. A display device mounting a touch panel comprising:
a display panel; and
a touch panel provided on the display panel,
the touch panel including:
a substrate;
a plurality of X electrodes formed on the substrate;
a plurality of Y electrodes formed on the substrate so as to intersect with the plurality of X electrodes; and
a protective film provided on the plurality of X electrodes and the plurality of Y electrodes,
wherein the pencil hardness of the surface on the observer side of the protective film is 3 or higher to 7 or lower.

9. A display device mounting a touch panel comprising:
a display panel; and
a touch panel provided on the display panel,
the touch panel including:
a substrate;
a plurality of X electrodes; and
a plurality of Y electrodes disposed so as to intersect with the plurality of X electrodes,
wherein the plurality of X electrodes and the plurality of Y electrodes have electrode parts and intersection parts;
the electrode parts and the intersection parts of the plurality of X electrodes and the electrode parts of the plurality of Y electrodes are formed on the substrate;
an insulating film is provided on the electrode parts and the intersection parts of the plurality of X electrodes and the electrode parts of the plurality of Y electrodes;
the intersection parts of the plurality of Y electrodes are formed on the insulating film;
each of the intersection parts of the plurality of Y electrodes allows the adjacent electrode parts of the plurality of Y electrodes to be electrically connected to each other through through-holes formed in the insulating film;
a protective film is provided on the intersection parts of the plurality of Y electrodes; and
the pencil hardness of the surface on the observer side of the protective film is 3 or higher to 7 or lower.

10. A display device mounting a touch panel comprising:
a display panel; and
a touch panel provided on the display panel,
the touch panel including:
a substrate;
a plurality of X electrodes formed on the substrate;
an insulating film formed on the plurality of X electrodes;
a plurality of Y electrodes formed on the insulating film so as to intersect with the plurality of X electrodes; and
a protective film provided on the plurality of Y electrodes,
wherein the pencil hardness of the surface on the observer side of the protective film is 3 or higher to 7 or lower.

11. The display device mounting a touch panel according to any one of claims 8 to 10, wherein the display panel is a liquid crystal display panel using a liquid crystal display device.

12. The display device mounting a touch panel according to any one of claims 8 to 10, wherein the pencil hardness of the surface on the observer side of the protective film is 4 or higher to 6 or lower.

13. The display device mounting a touch panel according to any one of claims 8 to 10, wherein the pencil hardness of the surface opposed to that on the observer side of the protective film is lower than that of the surface on the observer side of the protective film.

14. The display device mounting a touch panel according to any one of claims 8 to 10, wherein a front panel is provided on the protective film.

15. The display device mounting a touch panel according to any one of claims 8 to 10, wherein a transparent conductive film is provided on the surface opposed to that of the substrate on which the X electrodes and the Y electrodes are formed.
